(19) United States
(12) Patent Application Publication
(10) Pub. No.: US 2025/0094580 A1
(43) Pub. Date: Mar. 20, 2025

(54) DYNAMIC ANALYSIS FOR MALICIOUS BROWSER EXTENSIONS

(71) Applicant: Avast Software s.r.o., Prague 4 (CZ)

(72) Inventors: Iskander Sanchez-Rola, Antibes (FR); Venkadesan Marimuthu, Chennai (IN)

(73) Assignee: Avast Software s.r.o., Prague 4 (CZ)

(21) Appl. No.: 18/467,444

(22) Filed: Sep. 14, 2023

(51) Int. Cl. G06F 21/56

(52) U.S. Cl. CPC G06F 21/563; G06F 2221/033

(57) ABSTRACT

The behavior of browser extensions when installed and operating in a browser environment is monitored, such as by observing changes to a web page with and without the browser extensions installed. Document Object Model (DOM) changes to the web page, such as scripts that only run when an extension is installed, or other web content that changes as a result of differences in a web page with and without the browser extension installed are observed. These differences may be attributed to the browser extension, and the changed or added elements may be inspected for malicious content or behavior. If malicious behavior is found in the different content, the content and/or the browser extension may be flagged as malicious behavior and a signature used to identify the malicious browser extension in future applications.

### FIELD

The field relates generally to user privacy in using computerized devices, and more specifically in some embodiments to dynamic analysis for malicious browser extensions.

### BACKGROUND

Computers are valuable tools in large part for their ability to communicate with other computer systems and retrieve information over computer networks. Networks typically comprise an interconnected group of computers, linked by wire, fiber optic, radio, or other data transmission means, to provide the computers with the ability to transfer information from computer to computer. The Internet is perhaps the best-known computer network, and enables millions of people to access millions of other computers such as by viewing web pages, sending e-mail, or by performing other computer-to-computer communication.

But, because the size of the Internet is so large and Internet users are so diverse in their interests, it is not uncommon for malicious users to attempt to communicate with other users' computers in a manner that poses a danger to the other users. For example, a hacker may attempt to log in to a corporate computer to steal, delete, or change information. Computer viruses or Trojan horse programs may be distributed to other computers or unknowingly downloaded such as through email, download links, or smartphone apps. Further, computer users within an organization such as a corporation may on occasion attempt to perform unauthorized network communications, such as running file sharing programs or transmitting corporate secrets from within the corporation's network to the Internet.

For these and other reasons, many computer systems employ a variety of safeguards designed to protect computer systems against certain threats. Firewalls are designed to restrict the types of communication that can occur over a network, antivirus programs are designed to prevent malicious code from being loaded or executed on a computer system, and malicious behavior detection programs are designed to detect remailers, keystroke loggers, and other software that is designed to perform undesired operations such as stealing passwords or other information from a computer or using the computer for unintended purposes. Similarly, web browser anti-malicious behavior tools are used to verify the security and integrity of downloaded web content, and to identify and block potential vulnerabilities.

Such problems are compounded as web browsers and web content become increasingly complex, with modern browsers potentially processing executable code or scripts, distributing malware or code having malicious behavior, and capturing user information. For example, malicious web content may try to execute malicious scripts on the user's browser to steal personal data or perform illicit activities such as mining cryptocurrency. Similarly, information stored in the browser such as autofill information or login and password information are vulnerable to discovery, and other personal information may be revealed by observing cache or cookies stored by the web browser. Browser extensions may similarly pose a variety of risks, often altering the function or operation of the browser for a seemingly benign purpose but also surreptitiously stealing a user's personal information or performing other malicious functions.

Browser extensions pose a significant risk in part because of the breadth of functions they can perform, such as email encryption, ad blocking, and password management. To perform functions such as these, browser extensions are often given broad permission to process browser information, including almost everything your web browser sees. Malicious browser extensions therefore often masquerade as legitimate browser extensions that perform desirable functions, but may also perform malicious functions in the background. Various malicious browser extensions already found in the wild include extensions that secretly click on pay-per-click ads, that collect various user data, that intercept email messages, and that hijack user accounts such as Facebook accounts.

Installing browser extensions from reputable sources may help reduce the risk of downloading and installing malicious browser extensions, but even Google's official Chrome Web Store has been reported to include malicious versions of Chrome extensions masquerading as the real, benign extension. For reasons such as these, a need exists for a better way of managing potentially malicious browser extensions in a web browser.

### SUMMARY

One example embodiment comprises monitoring the behavior of browser extensions when installed and operating in a browser environment, such as by observing changes to a web page with and without the browser extensions installed. In a more detailed example, Document Object Model (DOM) changes to the web page, such as scripts that only run when an extension is installed, or other web content that changes as a result of differences in a web page with and without the browser extension installed are observed. These differences may be attributed to the browser extension, and the changed or added elements may be inspected for malicious content or behavior.

In a further example, if malicious behavior is found in the different content, the content and/or the browser extension may be flagged as malicious behavior and a signature used to identify the malicious browser extension in future applications.

The details of one or more examples are set forth in the accompanying drawings and the description below. Other features and advantages will be apparent from the description and drawings, and from the claims.

### BRIEF DESCRIPTION OF THE FIGURES

FIG. 1 is a block diagram of a server and user device configured to dynamically evaluate a browser extension for malicious behavior, consistent with an example embodiment.

FIG. 2 is a flow diagram illustrating a method of dynamically detecting malicious browser extensions, consistent with an example embodiment.

FIG. 3 is a computerized system employing a browser extension evaluation module, consistent with an example embodiment.

### DETAILED DESCRIPTION

In the following detailed description of example embodiments, reference is made to specific example embodiments by way of drawings and illustrations. These examples are described in sufficient detail to enable those skilled in the art to practice what is described, and serve to illustrate how elements of these examples may be applied to various purposes or embodiments. Other embodiments exist, and logical, mechanical, electrical, and other changes may be made. Features or limitations of various embodiments described herein, however important to the example embodiments in which they are incorporated, do not limit other embodiments, and any reference to the elements, operation, and application of the examples serve only to define these example embodiments. Features or elements shown in various examples described herein can be combined in ways other than shown in the examples, and any such combinations is explicitly contemplated to be within the scope of the examples presented here. The following detailed description does not, therefore, limit the scope of what is claimed.

As networked computers and computerized devices such as smart phones become more ingrained into our daily lives, the value of the information they store, the data such as passwords and financial accounts they capture, and even their computing power becomes a tempting target for criminals. Hackers regularly attempt to log in to computers to steal, delete, or change information, or to encrypt the information and hold it for ransom via “ransomware.” Smartphone apps, Java™ applets, browser extensions, and other such common files are all frequently infected with code having malicious behavior of various types, and users rely on tools such as antivirus software or other malicious behavior protection tools to protect their computerized devices from harm.

In a typical home computer or corporate environment, firewalls inspect and restrict the types of communication that can occur between local devices such as computers or IoT devices and the Internet, antivirus programs prevent known malicious files from being loaded or executed on a computer system, and malicious behavior detection programs detect known malicious code such as remailers, keystroke loggers, and other software that is designed to perform undesired operations such as stealing passwords and other information from a computer or using the computer for unintended purposes. These safeguards prevent infection from malicious behavior such as ransomware, and protect the user's personal information such as identity, credit card numbers, and computer use habits and interests from being captured by others. Tools such as these may inspect files stored on a user's device for malicious code, may examine code on execution or installation, and may inspect web content handled in a web browser such as downloaded scripts, extensions, and the like.

With the proliferation of web-based applications and services, web browsers and their capabilities have become increasingly complex. Modern web browsers can process executable code or scripts, automatically store and fill in personal information such as identity and username/password combinations, and employ executable extensions that add functionality and modify behavior of the web browser. Malicious code can attempt to steal passwords and users or other personal information such as stored autofill data, retrieve cookies or cache that may reveal similar personal user information, access browser history to identify a user's online behavior, or perform other malicious functions. Some malicious code attacks may not attempt to steal a user's information, but instead may use the user's computer for malicious purposes such as mining cryptocurrency, sending spam emails, performing distributed denial-of-service attacks, or performing other such functions.

Users rarely intentionally install or execute malicious code, which is instead often delivered hidden in other software such as a downloaded application, browser extension, or the like. Browser extensions are often given broad permission to monitor a user's web browser activities and change web browser behavior to perform useful functions such as implementing a password manager, in which the extension changes presentation of a web page by modifying the Document Object Model for the page, prompting a user for a master password, and filling in a stored username and password associated with the particular web page or domain being visited. Although these permissions are necessary for the password manager to function as intended, granting permissions necessary for a password manager to function may also enable a malicious extension to steal usernames and passwords. Other browser extensions may similarly be granted permissions for reasons that are or that appear legitimate, but that may be used for malicious purposes.

Browser extensions may alter the function or operation of the browser using methods such as changing the Document Object Model for a web page, which represents the web page or document in a way that allows programs such as JavaScript scripts or browser extensions to change the document's structure, style, and content. Because browser extensions perform a broad range of legitimate functions, such as email encryption, ad blocking, and password management that may provide them with access to private or sensitive information, browser extensions are often given broad permission to process browser information such as via the Document Object Model. Malicious browser extensions are therefore often hidden within or disguised as legitimate browser extensions that perform desirable functions, but that may also perform malicious functions hidden from the user.

Malicious browser extensions found in the wild include extensions that secretly click on pay-per-click ads, extensions that collect various user data, extensions that intercept email messages, and extensions that hijack user accounts such as Facebook accounts. Installing browser extensions from reputable sources may help reduce the risk of downloading and installing malicious browser extensions, but even Google's official Chrome Web Store has been reported to include malicious versions of Chrome extensions masquerading as the real, benign extension.

For reasons such as these, some examples presented herein provide for observing the behavior of browser extensions when installed and operating in a browser environment, such as by observing changes to a web page with and without the browser extensions installed. In a more detailed example, Document Object Model (DOM) changes to the web page, such as scripts that only run when an extension is installed, or other web content that changes as a result of differences in a web page with and without the browser extension installed are observed. These differences may be attributed to the browser extension, and the changed or added elements may be inspected for malicious content or behavior. If malicious behavior is found in the different content, the content and/or the browser extension may be flagged as malicious behavior and a signature used to identify the malicious browser extension in future applications.

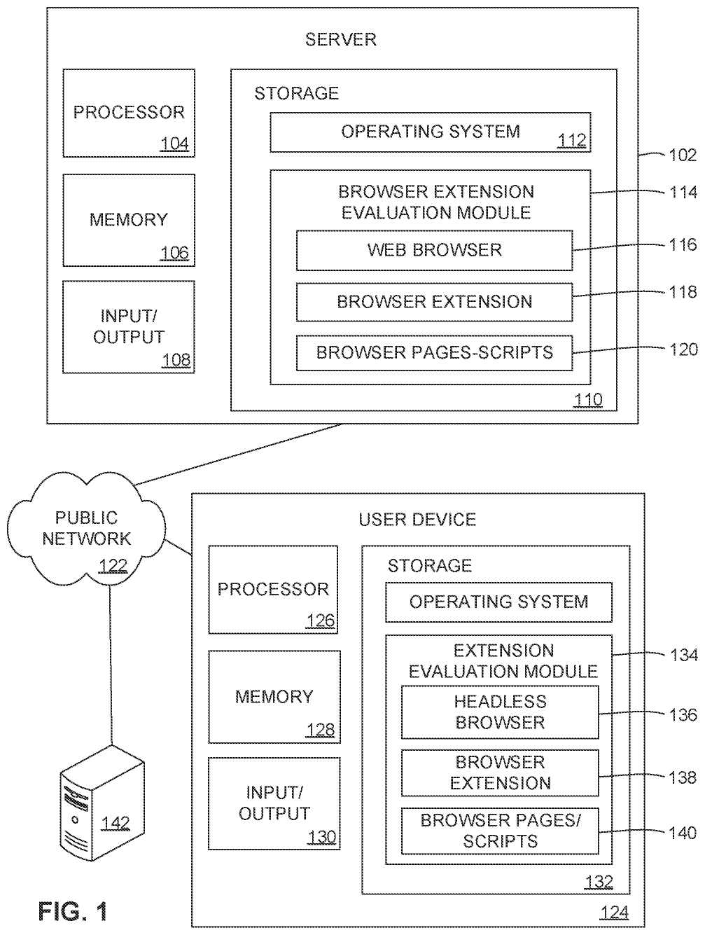

FIG. 1 is a block diagram of a server and user device configured to dynamically evaluate a browser extension for malicious behavior, consistent with an example embodiment. Here, the server 102 includes a processor 104 operable to execute computer program instructions and a memory 106 operable to store information such as program instructions and other data while computerized device 102 is operating. The server exchanges electronic data, receives input from a user, and performs other such input/output operations with input/output 108. Storage 110 stores program instructions including an operating system 112 that provides an interface between software or programs available for execution and the hardware of the server, and manages other functions such as access to input/output devices. The storage 110 also stores program instructions and other data for a browser extension evaluation module 114, including a web browser 116, one or more browser extensions 118, and browser pages and scripts 120 observed when browsing web pages using the web browser 116 with and without browser extension 118. In this example, the computerized device is also coupled via a public network 122 to one or more user devices 124, such as remote client computers or other smart phones, or other such computerized user devices, and to one or more remote web servers or domains 142.

In operation, one or more of user device 124 and server 102 execute a process to look for unrecognized or new browser extensions that have not been previously evaluated. When a new browser extension is found, a browser extension evaluation module such as 114 on server 102 installs the browser extension 118 in a web browser 116 such as a web browser executing in a sandboxed environment. The browser then executes with the browser extension installed, and loads one or more web pages from domains or web servers 142 while monitoring the web browser's behavior. The browser behavior while loading the one or more web pages is compared to the browser behavior when loading the same web pages with the browser extension not installed, and differences in scripts run, behavior, web page presentation, and the like are attributed to the browser extension. The one or more web pages loaded are in a further example determined at least in part by examining the browser extension, such as by looking at the manifest of the extensions such as for “host_permissions,” by looking at login pages or bookmarks stored in an extension such as a password manager, or by other domains or web pages indicated in the browser extension.

When a new browser extension is found and differences between web page presentation, script execution, or browser operation are found as a result of the browser extension, the differences are examined (manually and/or via automated tools) to determine whether the differences are malicious. If the differences are malicious, the browser extension can be considered malicious and various actions can be taken such as blocking installation or execution of the browser extension, creating a malicious behavior signature from the browser extension, or performing other such actions.

In another example, the user device 124 may be similarly operable to dynamically examine the behavior of new browser extensions using a browser extension module 134, which may use a “headless” web browser 136 that does not actively display web pages to a user but instead operates much like a normal web browser but without at least some user interface elements. The browser extension evaluation module 134 again installs a browser extension 138 into the headless browser 136, executes the browser, and loads one or more web pages, observing differences in the browser 136's presentation of the web page content, scripts that are run, and other such behaviors between browser instances with the browser extension 138 installed and instances with the browser extension 138 not installed. These differences are evaluated for malicious content or action, and may be used to characterize the browser extension as benign or malicious.

In a further example, browser extensions that modify the Document Object Model (DOM) of a web page are examined in the extension evaluation module such as 114 or 134 of FIG. 1, such that browser extensions that modify the Document Object Model of a web page as determined by comparing web pages loaded with and without the browser extension installed are analyzed for malicious action or content. In a more detailed example, an instrumented browser having one or more instruments or data monitoring and/or collection tools loads one or more web pages with the browser extension installed and uninstalled, gathering information such as identifying which scripts on the web page are associated with the browser extension. Because default scripts of browser extensions may be executed in an isolated environment they may not be directly observable, but the scripts typically inject additional code into the web page to modify it and these changes may be more readily observed and associated with the scripts that modified the web page code such as by modifying the web page's Document Object Model.

Tools such as an instrumented browser may also be used to dynamically supervise the creation and modification of any element of the Document Object Model of the web page, and may assist in attributing the modification to the responsible script such as through a generated stack trace. The specific changes that can be attributed to a browser extension can thereby be readily identified, and possible data risks or other malicious behavior characteristics of the changes can be evaluated. In a more detailed example, data risks or other malicious actions may be automatically detected or flagged for further review using tools such as examining if the browser extensions use an overlay (such as “getBoundingClientRect”) or modify user-interactable elements (e.g., “cursor:pointer”) such as login forms or buttons in an attempt to intercept user data such as login credentials or other information.

If a possible malicious extension that manipulates the Document Object Model is detected, a name and other identifying information may be extracted and signatures of code injected into the web page and/or interactions with the web pages may be stored to aid in identification of similar malicious browser extension behavior in future instances. Such signatures may be used in malicious behavior detection software, such as by detecting extensions installed in the browser using the extension ID and the corresponding browser folders (e.g. C:\Users\Username\AppData\Local\Google\Chrome\User Data\Default\Extensions for Chrome browsers in Microsoft Windows) for extensions matching the signature, or by a lightweight browser extension that dynamically looks for one or more portions of the created signature in other browser extensions, scripts, and/or modified web pages.

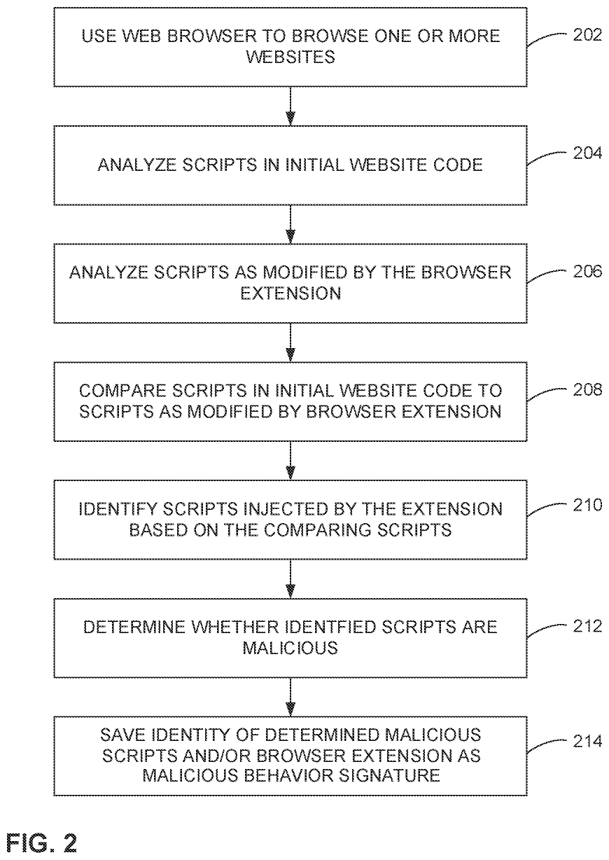

FIG. 2 is a flow diagram illustrating a method of dynamically detecting malicious browser extensions, consistent with an example embodiment. Such a process may be triggered when a new browser extension that is not recognized and that has not been previously analyzed locally is installed. In a further example, a data set of the most common browser extensions will be pre-analyzed and distributed as signatures to avoid duplicative analysis, and analysis of newly discovered extensions may be reported back to a central server for inclusion in the data set. In some examples, certain browser extensions that make changes in the Document Object Model for legitimate purposes that might appear suspect may be excluded, such as password managers, using browser extension categories, store tags, descriptions, or the like.

At 202, a web browser with a browser extension under test either uninstalled or inactive is used to load one or more web pages. The browser in some examples is an instrumented browser, such as a web browser having modifications made to provide for monitoring various states, functions, output, and/or input of the web browser. The instrumented browser in a further example is configured to perform one or more functions related to monitoring Document Object Model modifications to a web page, browser extension script execution, and/or other such features related to how a malicious browser extension might use the Document Object Model to modify a web page in a malicious way. The browser in another example is a headless browser, such as a browser that does not actively display a rendered web page to a user, but instead produces machine-readable output that may be automatically processed or logged.

The one or more websites selected for browsing at 202 in some examples comprise one or more websites from a list, or may browse one or more websites extracted from the manifest of the browser extension of interest such as “host_permissions” domains or web sites. In another example, pages obtained from another source, such as a password manager, may be used to ensure the browser extension does not attempt to capture passwords when logging in to such sites.

Scripts in the initial website code are analyzed for the one or more websites visited at 204, such as by observing how the visited websites are rendered without the browser extension under test installed. The same web pages are rendered with the browser extension of interest installed and the scripts observed in rendering the web page are again recorded at 206, such that the scripts observed when rendering the same web pages with the browser extension under test installed and without the browser extension under test installed can be compared at 208. The changes in scripts identified at 210 as a result of the comparison can be attributed to changes made via the Document Object Model of the web page by the browser extension.

In a more detailed example, a resource tree may be generated to allow identification of which scripts are associated with the browser extension under test, because extensions of default scripts typically are executed in an isolated environment that does not provide for direct monitoring. Because these scripts must inject code into the web pages such as via the Document Object Model of the web page to interact with certain objects on the web page, this injected code can be tracked and attributed to the browser extension under test. The resource tree in a further example includes retrieval of the origin of all code snippets or segments, and dynamically supervising the creation and modification of any element of the Document Object Model of the web page and attributing the element changes to the script responsible for such changes. The specific changes the browser extension is performing to the web page can therefore be identified and attributed to the browser extension.

These code changes or changes to the Document Object Model of the web page are analyzed at 212 to determine whether these changes are malicious, and the associated browser extension scripts and/or the browser extension are identified as malicious at 214 and a signature of the malicious script, browser extension, malicious web page change, or the like may be saved as a malicious behavior signature. Such signatures may then be used by anti-malware or anti-malicious behavior software to identify future instances of the malicious browser extension so that appropriate action such blocking installation or execution of the malicious extension may be performed.

These examples show how dynamic monitoring of a web page, web page code, scripts, a Document Object Model, and/or other such characteristics of a rendered web page with a browser extension under test may be performed to identify potentially malicious browser extensions. Behaviors that pose particular privacy risks that are directly attributable to the browser extension's modification to web page code, such as through the web page's Document Object Model, may be identified such as collecting private user data such as login credentials or various types of personally identifiable information. Although the example of FIG. 1 shows a server and a smart phone operable to perform various functions described in the examples herein, other computing devices may be used to implement these or other embodiments.

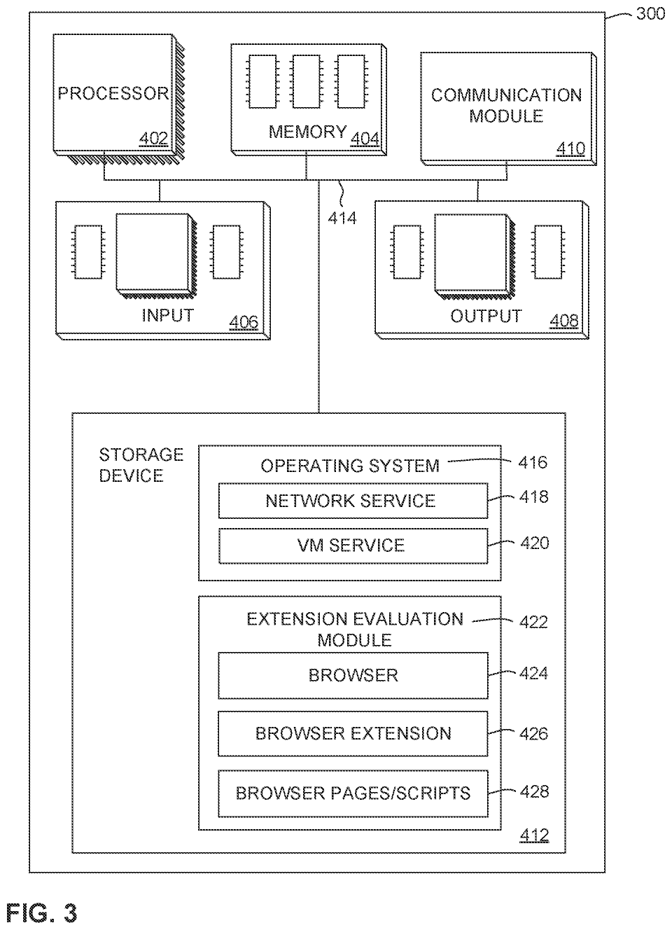

FIG. 3 is a computerized system employing a browser extension evaluation module, consistent with an example embodiment. FIG. 3 illustrates only one particular example of computing device 300, and other computing devices 300 may be used in other embodiments. Although computing device 300 is shown as a standalone computing device, computing device 300 may be any component or system that includes one or more processors or another suitable computing environment for executing software instructions in other examples, and need not include all of the elements shown here.

As shown in the specific example of FIG. 3, computing device 300 includes one or more processors 302, memory 304, one or more input devices 306, one or more output devices 308, one or more communication modules 310, and one or more storage devices 312. Computing device 300 in one example further includes an operating system 316 executable by computing device 300. The operating system includes in various examples services such as a network service 318 and a virtual machine service 320 such as a virtual server. One or more applications, such as browser extension evaluation module 322 are also stored on storage device 312, and are executable by computing device 300.

Each of components 302, 304, 306, 308, 310, and 312 may be interconnected (physically, communicatively, and/or operatively) for inter-component communications, such as via one or more communications channels 314. In some examples, communication channels 414 include a system bus, network connection, inter-processor communication network, or any other channel for communicating data. Applications such as browser extension evaluation module 322 and operating system 316 may also communicate information with one another as well as with other components in computing device 300.

Processors 302, in one example, are configured to implement functionality and/or process instructions for execution within computing device 300. For example, processors 302 may be capable of processing instructions stored in storage device 312 or memory 304. Examples of processors 302 include any one or more of a microprocessor, a controller, a digital signal processor (DSP), an application specific integrated circuit (ASIC), a field-programmable gate array (FPGA), or similar discrete or integrated logic circuitry.

One or more storage devices 312 may be configured to store information within computing device 300 during operation. Storage device 312, in some examples, is known as a computer-readable storage medium. In some examples, storage device 312 comprises temporary memory, meaning that a primary purpose of storage device 312 is not long-term storage. Storage device 312 in some examples is a volatile memory, meaning that storage device 312 does not maintain stored contents when computing device 300 is turned off. In other examples, data is loaded from storage device 312 into memory 304 during operation. Examples of volatile memories include random access memories (RAM), dynamic random access memories (DRAM), static random access memories (SRAM), and other forms of volatile memories known in the art. In some examples, storage device 312 is used to store program instructions for execution by processors 302. Storage device 312 and memory 304, in various examples, are used by software or applications running on computing device 300 such browser extension evaluation module 322 to temporarily store information during program execution.

Storage device 312, in some examples, includes one or more computer-readable storage media that may be configured to store larger amounts of information than volatile memory. Storage device 312 may further be configured for long-term storage of information. In some examples, storage devices 312 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 300, in some examples, also includes one or more communication modules 310. Computing device 300 in one example uses communication module 310 to communicate with external devices via one or more networks, such as one or more wireless networks. Communication module 310 may be a network interface card, such as an Ethernet card, an optical transceiver, a radio frequency transceiver, or any other type of device that can send and/or receive information. Other examples of such network interfaces include Bluetooth, 4G, LTE, or 5G, WiFi radios, and Near-Field Communications (NFC), and Universal Serial Bus (USB). In some examples, computing device 300 uses communication module 310 to communicate with an external device such as via public network 122 of FIG. 1.

Computing device 300 also includes in one example one or more input devices 306. Input device 306, in some examples, is configured to receive input from a user through tactile, audio, or video input. Examples of input device 306 include a touchscreen display, a mouse, a keyboard, a voice-responsive system, a video camera, a microphone, or any other type of device for detecting input from a user.

One or more output devices 308 may also be included in computing device 300. Output device 308, in some examples, is configured to provide output to a user using tactile, audio, or video stimuli. Output device 308, in one example, includes a display, a sound card, a video graphics adapter card, or any other type of device for converting a signal into an appropriate form understandable to humans or machines. Additional examples of output device 408 include a speaker, a light-emitting diode (LED) display, a liquid crystal display (LCD), or any other type of device that can generate output to a user.

Computing device 300 may include operating system 316. Operating system 316, in some examples, controls the operation of components of computing device 300, and provides an interface from various applications such as browser extension evaluation module 322 to components of computing device 300. For example, operating system 316, in one example, facilitates the communication of various applications such as browser extension evaluation module 322 with processors 302, communication unit 310, storage device 312, input device 306, and output device 308. Applications such as browser extension evaluation module 322 may include program instructions and/or data that are executable by computing device 300. As one example, browser extension evaluation module 322 uses a browser 324 such as an instrumented browser with browser extension 426 installed to load or browse various web pages with various scripts injected via the browser extension such as may be stored at 428 to evaluate changes the browser extension imparts to various code segments and determine the scripts and source of the scripts associated with the changes. These and other program instructions or modules may include instructions that cause computing device 300 to perform one or more of the other operations and actions described in the examples presented herein.

Although specific embodiments have been illustrated and described herein, any arrangement that achieve the same purpose, structure, or function may be substituted for the specific embodiments shown. This application is intended to cover any adaptations or variations of the example embodiments of the invention described herein. These and other embodiments are within the scope of the following claims and their equivalents.

1. A method of evaluating a browser extension for malicious content, comprising:
installing the browser extension in a web browser having one or more instrumentation features;
using the web browser to browse one or more websites;
analyzing scripts in the initial website code;
analyzing scripts in the website code as modified by the browser extension;
comparing the scripts in the initial website code as modified by the browser extensions to the scripts in the initial website code; and
identifying scripts injected by the extension based on the comparing the scripts in the initial website code as modified by the browser extensions to the scripts in the initial website code.

2. The method of evaluating a browser extension for malicious content of claim 1, further comprising identifying modification of the Document Object Model of the one or more websites due to the script injected by the extension.

3. The method of evaluating a browser extension for malicious content of claim 2, further comprising evaluating the identified modification of the Document Object Model of the one or more websites for malicious behavior.

4. The method of evaluating a browser extension for malicious content of claim 3, further comprising extracting the identified modification of the Document Object Model determined to have malicious behavior as a malicious behavior signature.

5. The method of evaluating a browser extension for malicious content of claim 1, further comprising evaluating the one or more identified scripts injected by the extension for malicious behavior.

6. The method of evaluating a browser extension for malicious content of claim 5, further comprising extracting a signature of one or more identified scripts evaluated as having malicious behavior as a malicious behavior signature.

7. The method of evaluating a browser extension for malicious content of claim 1, wherein the browser is installed in a sandbox environment on a server.

8. The method of evaluating a browser extension for malicious content of claim 1, wherein the browser is a headless browser installed on a client device.

9. The method of evaluating a browser extension for malicious content of claim 1, wherein the method is initiated or triggered by observing installation of an unrecognized browser extension.

10. The method of evaluating a browser extension for malicious content of claim 1, wherein the one or more websites browsed are determined at least in part from websites identified by the browser extensions.

11. The method of evaluating a browser extension for malicious content of claim 10, wherein the one or more websites browsed are determined at least in part by a browser extension manifest.

12. A system, comprising:
a computing device comprising a processor and a nonvolatile storage, the nonvolatile storage comprising coded instructions that when executed on the computing device cause the computing device to:
cause the web browser to browse one or more websites;
analyze scripts in the initial website code;
analyze scripts in the website code as modified by the browser extension;
compare the scripts in the initial website code as modified by the browser extensions to the scripts in the initial website code; and
identify scripts injected by the extension based on the comparing the scripts in the initial website code as modified by the browser extensions to the scripts in the initial website code.

13. The system of claim 12, the instructions when executed further operable to cause the computing device to identify modification of the Document Object Model of the one or more websites due to the script injected by the extension.

14. The system of claim 13, the instructions when executed further operable to cause the computing device to evaluate the identified modification of the Document Object Model of the one or more websites for malicious behavior.

15. The system of claim 14, the instructions when executed further operable to cause the computing device to extract the identified modification of the Document Object Model determined to have malicious behavior as a malicious behavior signature.

16. The system of claim 12, instructions when executed further operable to cause the computing device to evaluate the one or more identified scripts injected by the extension for malicious behavior.

17. The system of claim 16, instructions when executed further operable to cause the computing device to extract a signature of one or more identified scripts evaluated as having malicious behavior as a malicious behavior signature.

18. The system of claim 12, wherein the system comprises one or more of a server having the browser installed in a sandbox environment and a client device executing the browser as a headless browser.

19. The system of claim 12, wherein the process is initiated or triggered by observing installation of an unrecognized browser extension.

20. The server of claim 12, wherein the one or more websites browsed are determined at least in part from one or more of websites identified by the browser extensions and from a browser extension manifest.
